(19) United States
(12) Patent Application Publication
(10) Pub. No.: US 2008/0033967 A1
(43) Pub. Date: Feb. 7, 2008

(54) Semantic aware processing of XML documents

(76) Inventor: Ravi Murthy, Fremont, CA (US)

Correspondence Address: HICKMAN PALERMO TRUONG & BECKER/ORACLE, 2055 GATEWAY PLACE, SUITE 550, SAN JOSE, CA, 95110-1083, US

(21) Appl. No.: 11/489,426

(22) Filed: Jul. 18, 2006

(51) Int. Cl. G06F 7/00; G06F 17/30; G06F 17/00

(52) U.S. Cl. 707/100; 715/234; 707/3; 715/237

(57) ABSTRACT

Semantic aware processing of XML documents treats elements that have different names but that are semantically equivalent as being the same element when performing operations that depend on element names, such as querying and schema validation. The semantic aware processing is based on a mapping that maps each element name of a set of semantically equivalent names to a “canonical tag name”.

### RELATED APPLICATION

This application is related to U.S. application Ser. No. 10/884,311, (Attorney Docket No. 50277-2512) entitled Index For Accessing XML Data, filed on Jul. 2, 2004 by Sivasankaran Chandrasekaran, the contents of which are herein incorporated by reference in their entirety for all purposes.

### FIELD OF THE INVENTION

The present invention relates to processing of XML data.

### BACKGROUND

The Extensible Markup Language (XML) is the standard for data and documents that is finding wide acceptance in the computer industry. XML describes and provides structure to a body of data, such as a file or data packet, referred to herein as an XML document or fragment thereof. The XML standard provides for tags that delimit sections of a XML entity referred to as XML elements. Each XML element may contain one or more name-value pairs referred to as attributes. The following XML Fragment A is provided to illustrate XML.

Fragment FA

```
<book>My book
    <publication publisher=”Doubleday”
                date=”January”></publication>
    <Author>Mark Berry</Author>
    <Author>Jane Murray</Author>
</book>
```

XML elements are delimited by a start tag and a corresponding end tag. For example, segment A contains the start tag <Author> and the end tag </Author> to delimit an element. The data between the elements is referred to as the element's content. In the case of this element, the content of the element is the text data Mark Berry.

An element is herein referred to by its element name. For example, the element delimited by the start and end tags <publication> and </publication> is referred to as publication.

Element content may contain various other types of data, which include attributes and other elements. Element book is an example of an element that contains one or more elements. Specifically, book contains two elements: publication and author. An element that is contained by another element is referred to as a descendant of that element. Thus, elements publication and author are descendants of element book. An element's attributes are also referred to as being contained by the element.

By defining an element that contains attributes and descendant elements, the XML document defines a hierarchical tree relationship between the element, its descendant elements, and its attribute. Any set of elements that have such a hierarchical tree relationship is referred to herein as a XML document or fragment.

### Node Tree Model

An important standard for XML is the XQuery 1.0 and XPath 2.0 Data Model. (see W3C Working Draft 9 Jul. 2004, which is incorporated herein by reference) One aspect of this model is that a XML document is represented by a hierarchy of nodes that reflects the hierarchical nature of the XML document. A hierarchy of nodes is composed of nodes at multiple levels. The nodes at each level are each linked to one or more nodes at a different level. Each node at a level below the top level is a child node of one or more of the parent nodes at the level above. Nodes at the same level are sibling nodes. In a tree hierarchy or node tree, each child node has only one parent node, but a parent node may have multiple child nodes. In a tree hierarchy, a node that has no parent node linked to it is the root node, and a node that has no child nodes linked to it is a leaf node. A tree hierarchy has a single root node.

In a node tree that represents a XML document, a node can correspond to an element. The child nodes of the node correspond to an attribute or another element contained in the element.

The node may be associated with a name. For example, the name of the node representing the element book is book. For a node representing the attribute publisher, the name of the node is publisher.

For convenience of expression, elements and other parts of a XML document are referred to as nodes within a tree of nodes that represents the document. Thus, referring to ‘My book’ as the value of the node with the name book is just a convenient way of expressing that the value of the element associated with node book is My book. The name of an element, attribute, or node is also referred to herein as a tag name.

The path for a node in a XML document reflects a series of parent-child links, starting from a node in a XML document to arrive at a particular node further down in the hierarchy. For example, the path from the root of XML document to node publication is ‘/book/publication’.

Proliferation of Tag Names for Same Semantic

One reason for the increasing popularity of XML is that the tag names, being comprised of text, can be used descriptively and are therefore used to convey the semantic of an element and attribute. For example, the element <address> is used to store data representing an address.

However, the tag names are often created by independent individuals or groups implementing a specific application or project. Hence, the same semantic may end up being represented by different tag names within different XML documents. Though there are some XML vocabularies emerging from standard committees or industry consortia, these still account for a very small fraction of the overall XML tag names being used. There is an ongoing proliferation of tag names, and many different tag names are being created, in ad-hoc fashion, to mean a similar or same semantic. This problem arises across groups within the same company and different companies.

For example, an address value may be represented by the element <Address> within one XML document, but may be represented by a different element <Addr> in another document. Further, these tags may be using different namespaces. For example, company C1 could be using <c1:Address> whereas company C2 uses <c2:Address>. From a XML point of view, these tags and the elements they define are different and are assumed to mean different things.

A set of tag names, that are different from each other, but that may be treated as being semantically identical, are referred to herein as semantically equivalent heterogeneous tag names as semantically equivalent names. In the above example, <Address>, <Addr>, <c1:Address>, and <c2:Address> have semantically equivalent heterogeneous tag names.

Tag Name Proliferation Within a Repository

There are many scenarios when XML documents based on different vocabularies (i.e. set of tag names) end up in a single repository (such as a XML database). This is common in data integration, web services, and content routing. In such cases, it is very hard to formulate queries across a collection XML documents in the repository. In the above example, a query to check for the address across documents requires a complicated query that uses different tag names to access semantically equivalent elements in different documents.

One possible formulation of such a query is:

select . . . from PurchaseOrder
where extractvalue(doc, ‘/PurchaseOrder/Address’) = ‘1600
Willow St.’
or extractvalue(doc, ‘/PurchaseOrder/Addr’) = ‘1600
Willow St.’;

Clearly, as the complexity of the XPath expressions used increases, and the number of semantically equivalent tag names increase within the XML collection, the above approach becomes infeasible. In addition to the complexity of the queries, such queries suffer from poor performance. This defect is suffered by all standard query and transformation languages for XML, such as XPath, XQuery and XSLT.

Tag name proliferation for non-leaf nodes compounds the problems of tag name proliferation. If descendants of ascendant nodes have the same tag name but the ascendants have semantically equivalent but different names, different path strings are required to refer to the descendents. For example, several sets of XML documents include an element representing a publisher and its address. However, in one subset the element <publisher> is used and in another the element <publishing company> is used. Both contain the descendant elements <address>, <city>, and <zip>. Even though for both subsets the same tag name is used to represent the semantically equivalent descendant elements, between subsets different XPath strings must be used to identify the descendant elements. For example, to refer to the element <address>, in one subset the XPath string/publisher/address/is used and in the other the XPath string/publishing company/address/is used.

Another approach to address tag name proliferation is to normalize all documents to use the same tag names for the same semantic. For example, change within a collection of XML documents all semantically equivalent address elements to <Address>. Then a query accessing the address elements with the XML collection need only refer to one tag name. The major disadvantage of this approach is that the original document fidelity is not preserved.

Based on the foregoing, there is need for an improved way of addressing tag name proliferation.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an XML index based on semantic pathids according to an embodiment of the present invention.

FIG. 2 depicts a semantic aware rewrite of a query to according to an embodiment of the present invention.

FIG. 3 depicts a computer system that may be used in an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Described herein are approaches that allow semantically equivalent heterogeneous tags to be treated as the same tag name when performing “tag name operations.” A tag name operation is an operation that depends on the tag name of nodes. Examples of tag name operations include computing a query that references XML data using an XPath string, such as query QA. Another example of tag name operation is schema validation, in which it is determined whether a XML document conforms to a XML schema.

The approach is based on a mapping that maps each tag name of a set of semantically equivalent tag names to a “canonical tag name”. The semantically equivalent tag names are referred to individually as synonyms of the canonical tag name and of each other. Tag-name operations are performed as if the synonyms are identical to the canonical tag name to which they are mapped. Performing tag name operations in this manner is referred to herein as semantic aware processing.

For example, a collection of XML documents contains the following semantically equivalent set of address tag names: Address, Addr, c1:Address, and c2:Address.

The following XML fragment XA maps these semantically equivalent address tag names to the canonical tag name Address.

Fragment XA

```
<element name=“Address”>
    <synonym name=“Addr”/>
    <synonym name=“c1:Address/>
    <synonym name=“c2:Address/>
```

When computing the following query QB,

select . . . from PurchaseOrder
where extractvalue(doc, ‘/PurchaseOrder/Address’) = ‘500’

the elements identified by following paths are treated as being within path

/PurchaseOrder/Address specified in query QB:
/PurchaseOrder/Address,
/PurchaseOrder/Addr,
/PurchaseOrder/c1:Address, and
/PurchaseOrder/c2:Address.

A mapping that maps synonyms to a canonical tag name is referred to herein as a semantic mapping. Use of a XML document or fragment, such as Fragment A, is an example of one way of representing a semantic mapping. The present invention is not limited to any particular way of representing a synonym mapping.

According to an embodiment of the present invention, semantic aware processing of tag name operations is performed by a XML repository. A XML repository, as the term is used herein, is a computer system that stores and manages access to XML documents. Specifically, a repository is a combination of integrated software components and an allocation of computational resources, such as memory, disk storage, a computer, and processes on the node for executing the integrated software components on a processor, the combination of the software and computational resources being dedicated to managing storage and access to XML documents. Typically, the repository is used to store and access XML documents on behalf of clients that issue queries to access or manipulate the XML documents. The queries processed by a repository conform to XML standards such as XML Query Language (“XQuery”) and XML Path Language (“XPath”). XPath is described in XML Path Language (XPath), version 1.0 (W3C Recommendation 16 Nov. 1999), which is incorporated herein by reference. XPath 2.0 and XQuery 1.0 are described in XQuery 1.0 and XPath 2.0. (W3C Candidate Recommendation, 3 Nov. 2005), which is incorporated herein by reference.

Pathids and Indexes

According to an embodiment of the present invention, a XML repository uses semantic pathid indexes. A pathid is an identifier for the path within a XML document from a node to another node. The path for a node in a XML document reflects a series of parent-child links, starting from a node in a XML document to arrive at a particular node further down in the hierarchy. Paths are represented by path expressions, which are often strings representing a concatenation of names of nodes in a path. For example, the path from the root of XML document D2 to node Publication is represented by the path expression ‘/Book/Publication’.

The names of nodes can be very long. To reduce the length of a path expression, and lessen the amount of storage needed to store the path expression, pathids may be used in lieu of name based path expressions.

A pathid is comprised of node-id codes that are used in lieu of node names. In a pathid, there is a node-id code for each corresponding node name of a name based path expression.

For purposes of illustration, consider two XML documents:

```
                    Document D1
<Purchase Order>
. . .
    <Addr>10 Main St</Address>
. . .
</Purchase Order>
                    Document D2
<Purchase Order>
. . .
    <Address>500 Oracle Pkwy</Addr>
. . .
</Purchase Order>
```

Node-id codes 12, 23, and 24 are assigned to nodes PurchaseOrder, Addr, and Address, respectively. The path-id for path ‘/Purchase Order/Addr’ is thus ‘/12/23’; the path-id for ‘/Purchase Order/Address’ is ‘/12/24’. Further the path-ids may themselves be stored in a separate system path-id table that assigns shorter identifiers for the entire path, 42 for ‘/12/23’ and 43 for ‘/12/24’.

Path-ids may be used to generate indexes that index nodes in a collection of XML documents by pathid. Because pathids use less storage space, the path-id indexes index nodes to be indexed based on their paths without incurring the storage overhead of indexing path expressions based on full node names. Index For Accessing XML Data describes examples of an index that includes a path table and secondary indexes.

Semantic Path-ids

Semantic pathids are pathids generated based on the semantic equivalent of a path expression. For a given path expression, its semantic equivalent name-based path expression consists of a canonical tag name in lieu of its synonym. The synonym mapping is used to determine to which canonical tag name a synonym maps. A semantic pathid is based on the node-id codes of a semantic equivalent path expression; a node-id code of a canonical tag name is used in lieu of the node-id code of synonyms of the canonical tag name. For example, the node-id code of canonical tag name ADDRESS is 25. The semantic path-id for path ‘/Purchase Order/Addr’ is thus ‘/12/25’, and for ‘/Purchase Order/Address’ is ‘/12/25’ too.

Just as with path-ids, indexes may index nodes in a collection of XML documents by semantic pathids of the nodes. Such indexes are referred to herein as semantic aware indexes. Nodes that have semantically equivalent paths are indexed to the same semantic path-ids, an aspect of semantic indexes that can be used to optimize query and retrieval of XML data from nodes with semantically equivalent heterogeneous names. How this may be accomplished is illustrated within the context of a XML repository that comprises object/relational database server that is configured and/or enhanced for storing and querying XML documents.

XML Storage on Repository/Database Server

According to an embodiment, a XML repository is comprised of an object/relational database server that is configured and/or enhanced for storing and querying XML documents. In such a database server, a XML document may be stored in a row of a table and nodes of the XML document are stored in separate columns in the row. An entire XML document or fragment thereof may also be stored in a lob (large object) in a column. A XML document may also be stored as a hierarchy of objects in a database; each object is an instance of an object class and stores one or more elements of a XML document. The object class defines, for example, the structure corresponding to an element, and includes references or pointers to objects representing the immediate descendants of the element. Tables and/or objects of a database system that hold XML values are referred to herein as base tables or objects.

The object-relational database server executes queries that conform, at least in part, to XML standards, such as XQuery/XPath, and other standards, such the SQL/XML standard (see INCITS/ISO/IEC 9075-14:2003, which is incorporated herein by reference).

For purposes of exposition, embodiments of the present invention shall be illustrated with reference to a repository in the form of a database server that comprises an object/relational database server that is configured and/or enhanced for storing and querying XML documents, and with reference to base data structures used by a such database server to store XML data. However, an embodiment of the present invention is not limited to such a repository.

### Indexes

According to an embodiment, a database server maintains a “logical index” that indexes the collection of XML documents. A logical index may contain multiple structures that are cooperatively used to access another body of data, such as a set of one or more XML documents. According to an embodiment of the present invention, a logical index is referred to herein as an XML index, and includes a path table, which contains information about the hierarchy of nodes in a collection XML documents and may contain the value of the nodes. The logical index may include other indexes, including ordered indexes that index the path table. An ordered index contains entries that have been ordered based on an index key.

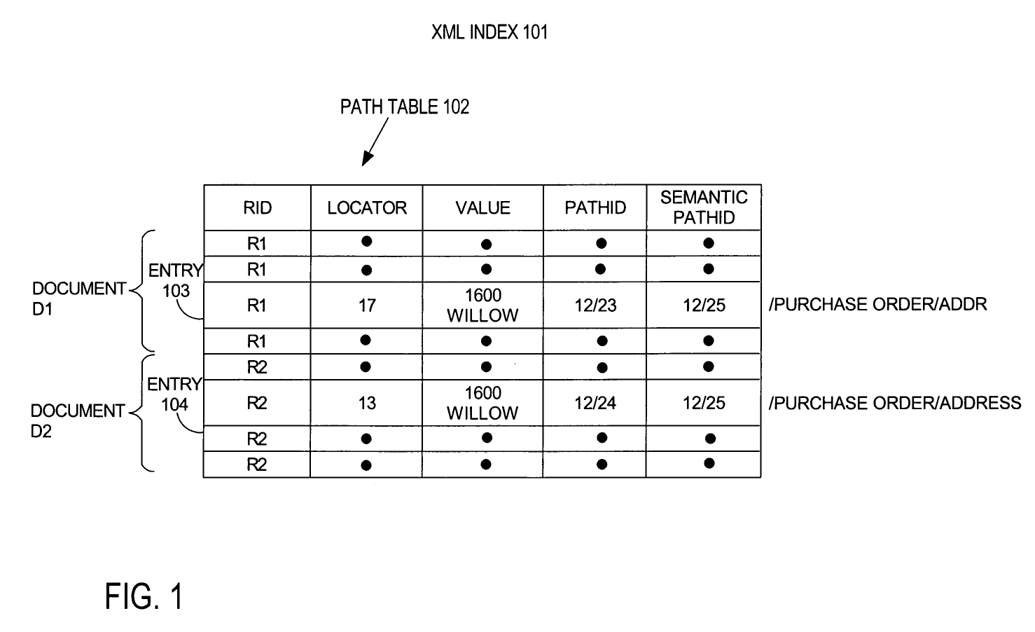

FIG. 1 shows a path table 102 of an XML index, according to an embodiment. A path table contains hierarchical information about a collection of XML documents. Path table 102 is illustrated with reference to documents D1 and D2.

Path table 102 includes columns RID, LOCATOR, VALUE, ORDERKEY, PATHID, and SEMANTIC PATHID. Rows in path table 102 each correspond to a node in the collection of XML documents that includes documents D1 and D2. Column RID includes row-ids of rows. For the node of a particular row in path table 102, the row-id identifies the row in the base table that contains the node. One set of entries of path table 102 identifies row RI, which holds the nodes of document D1 in a LOB column. Entry 103 corresponds to node/Purchase Order/Addr in document D1. Another set of entries of path table 102 identifies row R2, which contains the nodes of document D2. Entry 104 corresponds to node /Purchase Order/Address in document D1.

Column LOCATOR contains node locators, which are values indicating the location of a node within a data representation of a XML document. For example, for a stream of text representing a XML document, a node locator may be a value that represents the beginning byte position, within the stream of text, of the text representing the node. As another example, a set of related objects may represent the nodes of a XML document. A node locator may be a reference to the object that represents the node.

Column VALUE contains the values of nodes. Alternatively, a path table may omit a column that holds values of nodes. The values can be obtained by retrieving them from the location identified by a node locator.

Column PATHID holds pathids. For an entry and its respective node, the column PATHID holds the pathid of the node. For the entry of node/Purchase Order/Addr, PATHID holds value ‘12/23’. For the entry of/Purchase Order/Address, PATHID holds value ‘12/24’.

Column SEMANTIC PATHID holds semantic pathids. For an entry and its respective node, the SEMANTIC PATHID holds the semantic pathid of the node. Because /Purchase Order/Addr and /Purchase Order/Addr have semantically equivalent paths, their respective semantic pathids in colurn SEMANTIC PATHID are identical, which is ‘12/25’.

### Registering Semantic Mappings for Tag Name Operations

A user may register with a repository a semantic mapping for a collection of XML documents, causing the repository to perform tag name operations on the XML documents in a semantic aware manner, according to the registered semantic mapping. According to an embodiment, the registration occurs during a process of creating a semantic aware index. For example, to create a semantic index, a user issues DDL (“data definition language”) commands to a database server to create a XML index for a collection of XML documents. The commands refer to a XML document, stored by the database server, that represents the semantic mapping. In response to receiving the command, the database server executes the command, creating a semantic aware index based on the registered semantic mapping. The database server subsequently performs tag name operations based on and according to the semantic mapping. When documents are added to a XML collection indexed by the semantic aware index, the index is maintained according to the semantic mapping.

### Semantic Aware Rewrite of a Query

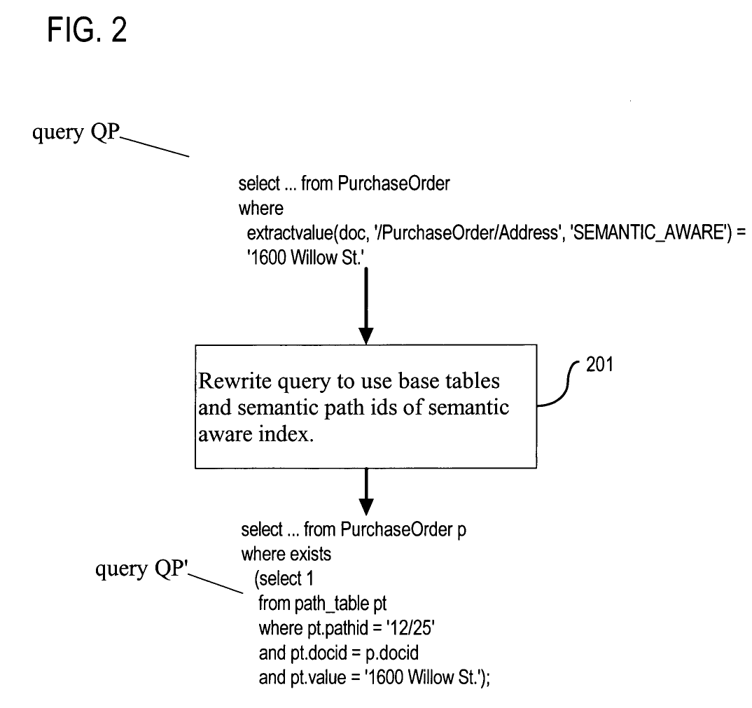

FIG. 2 depicts a query rewrite operation in which a database server rewrites a query QP so that the query is computed in a semantic aware fashion.

Query QP is issued by a user against a collection of XML documents that include XML documents D1 and D2. Query QP includes a extractvalue function with a parameter value ‘SEMATIC_AWARE’, which specifies that query QP is to be evaluated in a semantic aware way. Semantic aware processing, such as computation of a query, can be indicated in various ways; the present invention is not limited to any particular way. Semantic aware processing could be specified system wide; for example, a user could specify that all queries issued against a collection of XML documents should be subjected to semantic aware processing. Semantic aware processing could be specified at the session level, by, for example, a client establishing a session with a database server, or by an explicit query parameter, as illustrated by query QP.

Because Fragment XA has been registered with the database server as a semantic mapping for the XML collection, the semantic aware rewrite is based on this semantic mapping and path table 102.

At step 200, Query QP is rewritten to query QP′, which looks for entries that match the semantic equivalent pathid of the path provided by the extractvalue function. The semantic equivalent pathid is ‘12/25’. It was generated based on the semantic mapping registered for the XML collection. Note that the document D2 is selected by query QP′ even though the actual path within the document is /PurchaseOrder/Addr (not /PurchaseOrder/Address).

### Other Embodiments

As mentioned before, the approaches described are applicable to various forms tag name operations, and are not limited to query computation or evaluation. Another example of a tag name operation is schema validation. Schema validation determines whether a XML document conforms to an XML schema.

An XML schema defines the structure of specific types of XML documents. For example, the XML schema may specify the names for the elements contained in a XML document, the hierarchical relationship between the elements contained in the XML document, and the type of values contained in the XML document. Standards governing XML schemas include XML Schema, Part 0, Part 1, Part 2, W3C Recommendation, 2 May 2001, the contents of which are incorporated herein by reference, XML Schema Part 1: Structures, Second Edition, W3C Recommendation 28 Oct. 2004, the contents of which are incorporated herein by reference, and XML Schema Part 2: Datatypes Second Edition, W3C Recommendation 28 Oct. 2004, the contents of which incorporated herein by reference.

Under semantic aware schema validation, a particular node with a semantic equivalent name to a node defined in a XML schema is treated as the same even though the true name of the particular node differs from the schema defined node. Semantic equivalence is determined based on a semantic mapping, such as the semantic mapping represented by Fragment XA.

For example, a schema may define a XML document to contain element <address> as a child <purchase order>. Without semantic aware processing, document D1 is not considered as conforming to the XML schema because the document contains the different but semantically equivalent element <Addr>. Under semantic aware processing, document D1 is considered to be conforming because, based on the semantic mapping, the element <Addr> is treated as being identical to <Address>.

### Hardware Overview

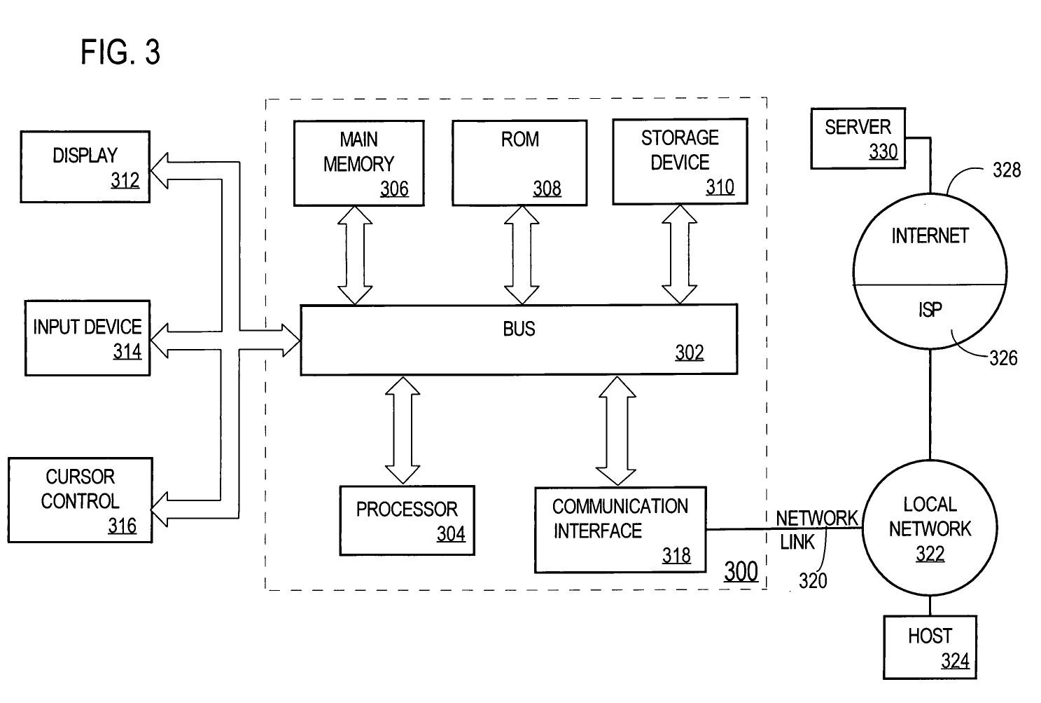

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising the computer-implemented steps of:
storing a semantic mapping that maps a canonical tag-name to both a first name of a first node and to a second name of a second node, different than said first name, wherein a collection of XML documents includes said first node and said second node; and
based on the semantic mapping, performing a tag name operation by treating said first name and second name as identical names.

2. The method of claim 1, wherein the tag name operation is computation of a query issued against said collection of XML documents.

3. The method of claim 1, wherein the tag name operation includes a schema validation.

4. The method of claim 1, wherein said tag name operation is performed by a repository that manages access to said collection of XML documents.

5. The method of claim 4, wherein the computer-implemented steps further include:
receiving a request to register data representing said semantic mapping; and
in response to said request, registering said data as said semantic mapping.

6. A method, comprising the computer-implemented steps of:
for each node of a plurality of nodes in a collection of XML documents, generating a semantic pathid based on a semantic mapping;
wherein the plurality of nodes include a first node and a second node;
wherein a first name is associated with the first node or an ascendant node of said first node;
wherein a second name is associated with the second node or an ascendant of said second node;
wherein the semantic mapping maps a canonical tag-name to said first name and to said second name;
wherein the semantic pathid generated for said first node and said second node are identical.

7. The method of claim 6, wherein:
the semantic pathid for said each node includes a code for each name of a node in the path of said each node; and
the code for the first name and the code for the second name are the same.

8. The method of claim 6, the computer-implemented steps further including:
creating an index that indexes said plurality of nodes by the semantic pathids generated for said plurality of nodes.

9. The method of claim 6, wherein said collection of XML documents is managed by a database server, the computer-implemented steps further comprising:
receiving a query issued against the collection of XML documents, said query specifying a path; and
based on said path, a database server rewriting said query to access said index.

10. A computer-readable medium carrying one or more sequences of instructions which, when executed by one or more processors, causes the one or more processors to perform the method recited in claim 1.

11. A computer-readable medium carrying one or more sequences of instructions which, when executed by one or more processors, causes the one or more processors to perform the method recited in claim 2.

12. A computer-readable medium carrying one or more sequences of instructions which, when executed by one or more processors, causes the one or more processors to perform the method recited in claim 3.

13. A computer-readable medium carrying one or more sequences of instructions which, when executed by one or more processors, causes the one or more processors to perform the method recited in claim 4.

14. A computer-readable medium carrying one or more sequences of instructions which, when executed by one or more processors, causes the one or more processors to perform the method recited in claim 5.

15. A computer-readable medium carrying one or more sequences of instructions which, when executed by one or more processors, causes the one or more processors to perform the method recited in claim 6.

16. A computer-readable medium carrying one or more sequences of instructions which, when executed by one or more processors, causes the one or more processors to perform the method recited in claim 7.

17. A computer-readable medium carrying one or more sequences of instructions which, when executed by one or more processors, causes the one or more processors to perform the method recited in claim 8.

18. A computer-readable medium carrying one or more sequences of instructions which, when executed by one or more processors, causes the one or more processors to perform the method recited in claim 9.

19. A computer-readable medium storing an index of a plurality of nodes in a collection of XML documents, wherein:
each node of said plurality of nodes is associated with a certain path that includes said each node;
each entry of said index corresponds to a particular node of said plurality of nodes and associates said node with a semantic pathid representing the certain path of said particular node;
the plurality of nodes include a first node and a second node;
a first name is associated with the first node or an ascendant node of said first node;
a second name is associated with the second node or an ascendant node of said second node; and
the respective semantic pathids for said first node and said second node are identical.

20. The computer-readable medium of claim 10, wherein:
the semantic pathid for said each node includes a code for each name of a node in the path of said each node; and
the respective code for the first name and the second name are the same.
